(19) United States
(12) Patent Application Publication
(10) Pub. No.: US 2024/0242539 A1
(43) Pub. Date: Jul. 18, 2024

(54) CONVERTING 3D FACE LANDMARKS

(71) Applicant: International Business Machines Corporation, Armonk, NY (US)

(72) Inventors: Wen Ting SU, Beijing (CN); Yuan Jie SONG, Shanghai (CN); Dan ZHANG, Shanghai (CN); Yu LI, Beijing (CN); Meng CHAI, Shanghai (CN); Xiao Feng JI, Shanghai (CN)

(21) Appl. No.: 18/154,652

(22) Filed: Jan. 13, 2023

(51) Int. Cl. G06V 40/16

(52) U.S. Cl. CPC G06V 40/176; G06V 40/169

(57) ABSTRACT

Embodiments of the present disclosure provide enhanced system and methods for implementing generative converting 3D face landmarks. An enhanced disclosed system and non-limiting method effectively renders a third 3D face model of a first user that enables a second user to easily recognize the first user, where the second user is only familiar with a first face model that is significantly changed in a second face model of the first user in a current interaction of the first user and second user. This method effectively renders the third 3D face model of the first user that can gradually change from the first face model to the second face model, and can be easily recognized by the second user.

### BACKGROUND

The present invention relates to the data processing field, and more specifically, to a generative method for converting 3D face landmarks in a virtual-reality environment.

Metaverse is a virtual-reality space in which users can interact with a computer-generated environment and other users. Augmented reality (AR) augments a user's surroundings by adding digital elements to a live view, such as by using the camera on a smartphone. Virtual reality (VR) is a completely immersive experience that replaces a real-life environment with a simulated environment. An avatar is an electronic image that represents a particular person or computer user in video games, internet forums, and the like, and can be manipulated by a computer user (as in a computer game).

Currently the metaverse is becoming an active field of interest, and virtual avatars can be the most important agents participating in the interactions and engagements. Due to the pursuit of individuality and the changing aesthetics over time, people can undergo plastic surgery in the real world, or otherwise adjust or replace the 3D face models of their avatars. As a result, with their latest avatar's 3D face presented, they can hardly be recognized by even the closest friends and oftentimes be mistaken for strangers.

A person can be recognized by an alias or nickname but these can also change. Other identification information, for example consisting of letters or numbers, such as mobile phone number, e-mail address, assigned system number (like WeChat ID), can be difficult to remember, and also may not be disclosed to public by systems due to privacy concerns. Such identification information is not the best way to recognize the person who changes their avatar's 3D face models in the metaverse.

In addition, the human brain has a special functional area for face recognition, so the fastest, most convenient, and intuitive way to recognize a person is through directly identifying a 3D face model generated from scanning features of the person's actual face, just the way people interact with each other in the real world. However, when the 3D face model of the friend's avatar has been changed; the human brain may not recognize them as a friend. As such, a significant problem that exists in current systems is the inability to enable users to recognize and identify another user when the user's avatar has changed.

New techniques are needed to enable enhanced face recognition and identification of an avatar of another user in a virtual environment, when the other user's avatar has changed. For example, new techniques are needed to enable effectively and efficiently implementing a 3D face model that enables a user to recognize and identify the other user's avatar, and that overcome deficiencies of current systems.

### SUMMARY

Embodiments of the present disclosure are directed to a system and methods for generative converting 3D face landmarks. A non-limiting method for implementing generative converting 3D face landmarks enables a user to recognize and identify another user's avatar in a virtual environment when the other user's avatar has changed.

In a non-limiting method, historical 3D face landmarks of a first face model of a first user from a last historical interaction with a second user are accessed for use in a current interaction at a timepoint Tn of the first user and second user in a virtual environment. Current 3D face landmarks of a second face model of the first user at the current timepoint Tn are accessed wherein the current 3D face landmarks present an expression and pose of the first user. At the timepoint Tn, blended 3D face landmarks of the first user are generated, based on the expression and pose of the current 3D face landmarks of the second face model of the first user and conditioned on facial characteristics of the historical 3D face landmarks of the first user. A third current 3D face model for the first user displayed to the second user is rendered with the blended 3D face landmarks. This method effectively renders the third 3D face model of the first user, so that the first user can be easily recognized by the second user who is only familiar with the first face model of the first user.

In another non-limiting method, a face landmark of the current 3D face landmarks of a second face model and a face landmark of the blended 3D face landmarks of the third face model having a same face-landmark index are compared to identify a mismatched face landmark set at the timepoint Tn. After a set time interval at next timepoint Tn in the current interaction of the first user and second user, the mismatched face landmark set is processed to update the blended 3D face landmarks of the third face model. The updated blended 3D face landmarks are used to render the third face model for the first user. The third face model is displayed on an avatar of the first user in the virtual environment. This method effectively renders the third face model of the first user that can gradually change from that of the first face model to that of the second face model, and can be easily recognized by the second user.

In accordance with disclosed embodiments, generative converting 3D face landmarks comprises processing the mismatched face landmark set after the set time interval at subsequent next timepoints Tn in the current interaction of the first user and second user, when the mismatched face landmark set is not empty. A mismatched face landmark 1 and a mismatched face landmark 2 symmetrical to the landmark 1 of the mismatched face landmark set are randomly selected, and used to replace corresponding face landmarks with the same face-landmark index in the blended 3D face landmarks. The replaced corresponding face landmarks are saved providing updated blended 3D face landmarks. The updated blended 3D face landmarks are used to render a current third face model of the first user. The third face model is displayed on an avatar of the first user in the virtual environment. At subsequent timepoints Tn in the current interaction of the first user and second user, processing the mismatched face landmark set can be repeated until the mismatched face landmark set is empty. The method renders third face models of the first user after each subsequent time interval that sequentially incorporate updated blended 3D face landmarks, gradually changing from the facial characteristics of the first face model to that of the second face model.

In accordance with disclosed embodiments, another non-limiting computer implemented method comprises identifying an empty mismatched face landmark set, and rendering a current 3D face model of the first user presented to the second user with the current 3D face landmarks of the second face model, without further processing or any processing being conditioned on the historical 3D face landmarks of the first user.

Other disclosed embodiments include a computer system and computer program product for generative converting 3D face landmarks implementing features of the above-disclosed methods.

### BRIEF DESCRIPTION OF THE DRAWINGS

FIG. 1 is a block diagram of an example computer environment for use in conjunction with one or more disclosed embodiments for generative converting 3D face landmarks;

FIG. 2 is a block diagram of an example system for generative converting 3D face landmarks of one or more disclosed embodiments;

FIG. 3 is a flow chart illustrating example operations for generative converting 3D face landmarks of one or more disclosed embodiments;

FIG. 4 illustrates example operations to retrieve 3D face landmarks used to render the 3D face model of user A from within a related historical interaction record of one or more disclosed embodiments;

FIG. 5 illustrates an example Implementation model of functions and operations of iterative refinement of 3D face landmarks of a 3D Face Landmark Conversion Generator for implementing generative converting 3D face landmarks of disclosed embodiments;

FIG. 6 illustrates an example Implementation model of functions and operations to pretrain an encoder of FIG. 5, where two encoders share the same parameters, for generative converting 3D face landmarks of disclosed embodiments;

FIG. 7 illustrates an example Implementation model of functions and operations of an example two-stage training of a decoder for generative converting 3D face landmarks of one or more disclosed embodiments;

FIG. 8 illustrates example operations for updating blended 3D face landmarks used for generative converting 3D face landmarks of one or more disclosed embodiments; and

FIG. 9 is a flow chart illustrating example operations of a method for generative converting 3D face landmarks of one or more disclosed embodiments.

### DETAILED DESCRIPTION

A significant problem of current metaverse systems is an overall inability to enable users to recognize and identify another user when the user's avatar has changed. In general, existing systems do not address this problem, or offer any process to allow users to identify another user when the user's avatar has changed. Embodiments of the present disclosure provide new effective techniques enabling users to easily recognize others whose 3D face models of the user's avatar have been changed, and can be further changed many times in interactions in the metaverse.

Embodiments of the present disclosure provide new techniques enabling accurate and effective user identification in interactions between respective virtual avatars of first and second users in the metaverse. In a disclosed embodiment, historical 3D face landmarks of a first face model of the first user from a last historical interaction with the second user are accessed for use in a current interaction at a timepoint Tn of the first user and second user. At the current timepoint Tn, current 3D face landmarks of a second face model of the first user are accessed. The current 3D face landmarks of the second face model present an expression and pose of the first user. At the timepoint Tn, blended 3D face landmarks of the first user are generated, based on differences between the historical 3D face landmarks and the current 3D face landmarks of the first user. A third current face model of the first user presented to the second user is rendered with the blended 3D face landmarks. The expression and pose of the third face model matches the expression and pose of the second face model. That is, the face-landmark generative process renders the third face model of the first user conditioned on the historical 3D face landmarks, so that the third face model can incorporate all or partial facial characteristics of the first face model of the first user, easily recognized by the second user.

In a disclosed embodiment, a face landmark of current 3D landmarks and blended 3D landmarks having a same face-landmark index are compared to identify a mismatched face landmark set at the timepoint Tn. After a set time interval at next timepoint Tn in the current interaction of the first user and second user, the mismatched face landmark set is processed to update the blended 3D face landmarks. The updated blended 3D face landmarks are used to render a 3D face model for the first user. This method effectively renders the third 3D face model of the first user, so that the first user can be easily recognized by the second user who is only familiar with the first face model of the first user.

In accordance with disclosed embodiments, unless the mismatched face landmark set is empty processing of the mismatched face landmark set is repeated at subsequent next timepoints Tn after the set time interval in the current interaction of the first user and second user. A mismatched face landmark 1 and a mismatched face landmark 2 symmetrical to the landmark 1 of the mismatched face landmark set are randomly selected, and used to replace corresponding face landmarks with the same face-landmark index in the blended 3D face landmarks. The replaced corresponding face landmarks are saved providing updated blended 3D face landmarks. The updated blended 3D face landmarks are used to render a current third face model of the first user. At subsequent timepoints Tn in the current interaction, processing the mismatched face landmark set can be repeated until the mismatched face landmark set is empty. The method renders third face models of the first user after each subsequent time interval that sequentially incorporate updated blended 3D face landmarks of the third face model that gradually changes from the face characteristics of the first face model to that of the second face model.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

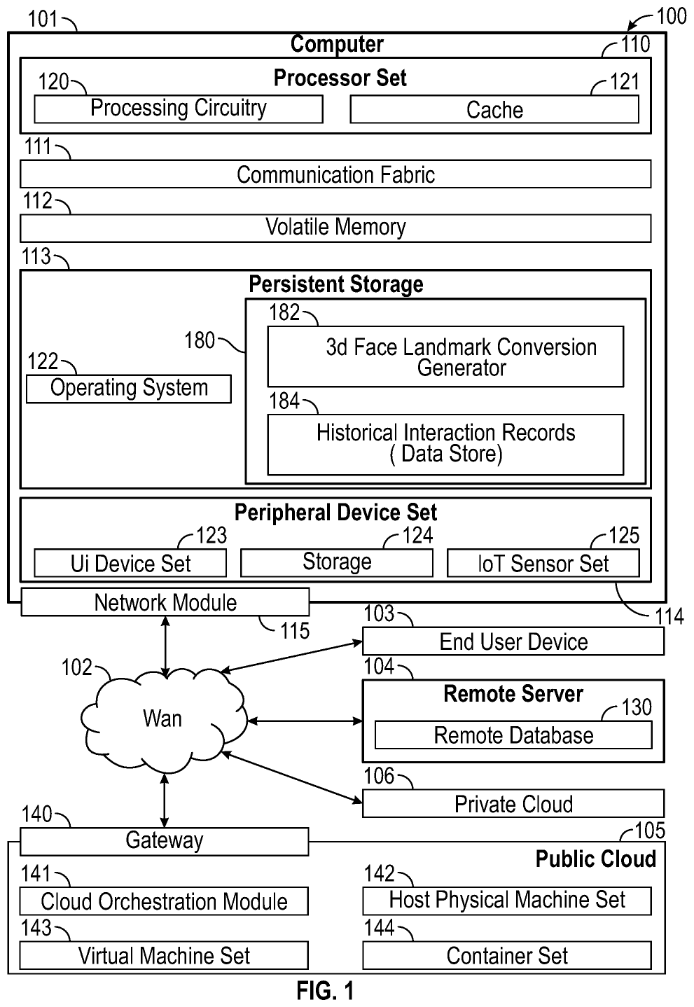

With reference now to FIG. 1, there is shown an example computing environment 100. Computing environment 100 contains an example of an environment for the execution of at least some of the computer code involved in performing the inventive methods, such as a 3D Face Landmark Conversion Generator 182 and Historical Interaction Records 184 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

An enhanced non-limiting disclosed method uses a 3D Face Landmark Conversion Generator 182 to generate a 3D third face model (3^{rd}) in a new interaction between respective virtual avatars of first and second users (both wearing AR/VR glasses) in the virtual environment. The generated 3D face model (3^{rd}) incorporates the facial characteristics of an input first face model (1^{st}) and the expression or pose of another input second face model (2^{nd}) at multiple timepoints Tn, (n=1, 2, 3, . . . ). In the generative converting 3D face landmarks process, the facial characteristics of the 3^{rd} face model can be gradually converted from that of the 1^{st} face model to that of the 2^{nd} one. As a result, users can easily recognize others whose 3D face models have been changed from time to time in the metaverse.

In one embodiment, the historical interaction record is a data structure comprising predefined information for first and second users who have interacted in the metaverse. The historical interaction record can include a unique identifier of the first user, and a unique identifier of the second user. In one embodiment, the historical interaction record includes a defined number of face landmarks, such as tens, hundreds, or thousands of 3D face landmarks, used to render the 3D face model of the first user at the last timepoint in the latest interaction with the second user. The historical interaction record can also include a corresponding number of 3D face landmarks, used to render the 3D face model of the second user at the last timepoint in the latest interaction with the first user.

The description below refers to three face models. Face model 1 (Face 1) is a first 3D face model of the first user from a last historical interaction with the second user. Face model 2 (Face 2) is the second or current 3D face model of the first user. Face model 2 can differ from Face model 1 because the user may have changed her face. For example, the user may have changed the physical traits of her face (e.g., performed cosmetic surgery). In one embodiment, the Face model 2 may be derived from sensors on a VR headset currently being worn by the user. Thus, if the user changes a physical trait of her face, this is detected by the VR headset and used to generate Face model 2. In another embodiment, the user has changed the virtual appearance of the avatar (e.g., altered the face model to include the nose or eye structure of her favorite actor or athlete) without changing the physical traits of her actual face. In this example, the Face model 2 may be a combination of the physical traits of her actual face and the altered characteristic such as a different noise structure.

Face model 3 (Face 3) is a third 3D face model, constructed by the 3D face landmarks that are generated based on the 3D face landmarks of Face 2 at timepoint Tn. Face 3 is constructed (using the 3D Face Landmark Conversion Generator 182 of FIG. 1), conditioned on the 3D face landmarks of Face 1 at timepoint T1; such generated face landmarks incorporate both the facial characteristics of Face 1 and the expression/pose of Face 2 at timepoint Tn. Other information required for rendering Face 3 (e.g. vertex texture coordinates) is inherited from Face 1 or 2.

In accordance with disclosed embodiments, a method for converting 3D face landmarks is provided for generating third 3D face models for the first user, so that the first user can be easily recognized by the second user who is only familiar with the first face model of the first user. The 3D Face Landmark Conversion Generator 182 generates third face models using historical 3D face landmarks of a first face model of the first user from a last historical interaction with the second user in a current interaction at a timepoint Tn of the first user and second user. Current 3D face landmarks of a second face model of the first user at the current timepoint Tn present an expression and pose of the first user in the current interaction. At the timepoint Tn, blended 3D face landmarks of a third face model of the first user are generated, include the expression and pose of the second face model of the first user and facial characteristics of the historical 3D face landmarks of the first face model. The third current 3D face model for the first user on an avatar of the first user in the virtual environment is presented to the second user. The third face model is a blend of the old first face model and the new second face model, which allows the second user to acclimate slowly to the new second face model of the first user. That is, this method effectively renders the third 3D face model of the first user, so that the first user can be easily recognized by the second user who is only familiar with the first face model of the first user. Overtime, the third 3D face model can be adjusted to become more like the second face model until eventually the second face model can be used to display the first user's avatar in the virtual world.

In the face-landmark generative method the 3D face landmarks of the second face model of the first user (that are captured at every timepoint Tn) are converted to that of the third face model, so that the third face model can incorporate the same expression and pose as that of the second face model at every timepoint. That is, the third face model can incorporate the current expression and pose as that of the second face model at each of the subsequent timepoints Tn in the current user interaction. In this manner, the third face model (which is a blend of the first and second face models) can display the current facial expressions of the first user (e.g., if the user is smiling, frowning, laughing, and the like). At each timepoint Tn, the 3D Face Landmark Conversion Generator 182 samples the 3D face landmarks of the third face model through iterative refinement of T steps. As a result of the iterative refinement, the facial characteristics of the third face model can be gradually changed from that of the first face model to that of the second face model.

The face-landmark generative process conditions on the 3D face landmarks used to render the face model of the first user at the last timepoint in the latest interaction with the second user, so that the third face model can incorporate all or partial facial characteristics of the first face model of the first user. The face-landmark generative process converts the 3D face landmarks of the second face model of the first user (that are captured at every timepoint) to that of the third face model, so that the third face model can incorporate the same expression and pose as that of the second face model at every timepoint. At each timepoint, the 3D Face Landmark Conversion Generator samples the 3D face landmarks of the third face model through iterative refinement of T steps. For example, in the current interaction of the users at each preset time interval point, a face landmark of the third face model is randomly replaced by a face landmark with the same face-landmark index of the second face model, which do not coincide in the 3D space corresponding to the perspective of the second user's AR/VR glasses, so that the facial characteristics of the third face model can gradually change from that of the first face model to that of the second face model.

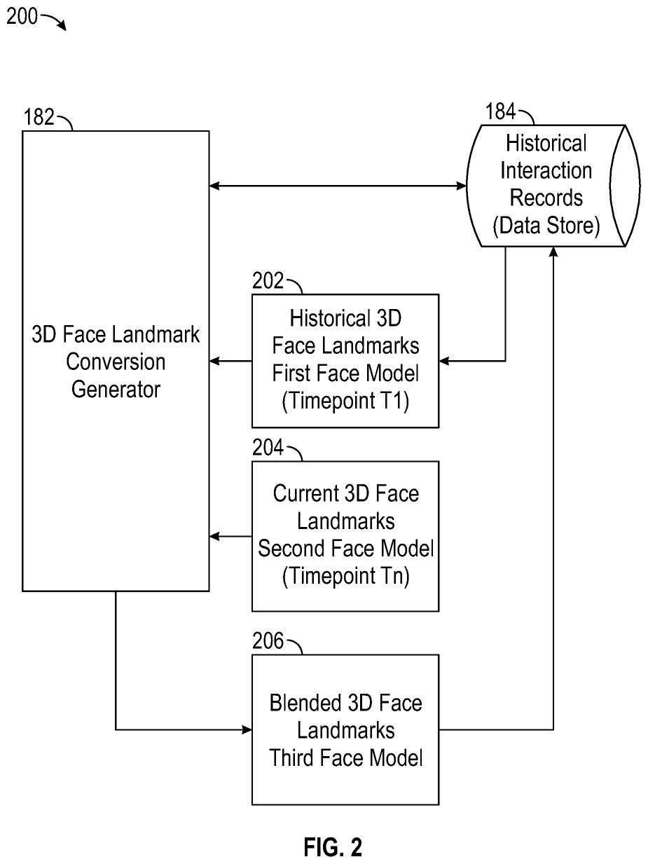

Referring to FIG. 2, there is shown an example system 200 for implementing generative converting 3D face landmarks of one or more disclosed embodiments. System 200 can be used in conjunction with computer 101 and cloud environment of the computing environment 100 of FIG. 1 for implementing generative converting 3D face landmarks of disclosed embodiments.

System 200 includes the 3D Face Landmark Conversion Generator 182 and Historical Interaction Records 184 (e.g., data store), for example used together with processor computer 101 of the computing environment 100 of FIG. 1 to implement third 3D face models of disclosed embodiments. In accordance with disclosed embodiments, system 200 is configured for constructing and supporting virtual interactive environments, and renders a third 3D face model of a user's virtual avatar in real time. System 200 saves historical interaction records in the Historical Interaction Records 184, for example that are not exposed to users or other systems.

The Historical Interaction Records 184 includes for example, predefined information for first and second users who have interacted in the metaverse. The historical interaction record can include a unique identifier of the first user and a unique identifier of the second user. The historical interaction record includes historical 3D face landmarks, used to render the 3D face model of the first user at the last timepoint in the last historical interaction with the second user. The historical interaction record includes corresponding historical 3D face landmarks, used to render the 3D face model of the second user at the last timepoint in the last historical interaction with the first user.

System 200 implements a generative method of converting 3D face landmarks of 3D face models, for example used to render third face models for a first user so that the first user can be easily recognized by the second user who is only familiar with a first face model (i.e., Face 1) of the first user while Face 1 has been replaced with a different (current) second face model (i.e., Face 2) of the first user.

System 200, constructing and supporting virtual interactive environments, obtains the real-time 3D face landmarks of the first user's face as the vertex positions (XYZ) of Face 1 or Face 2 in order to present in a rendered Face 3 the real-time expressions and poses of the first user in the metaverse. For example, various factors can cause the facial characteristics of Face 1 to be different from that of Face 2. For example, a facial plastic surgery undergone by the first user in the real world has changed her 3D face model accordingly. The VR headset worn by the first user can detect these physical changes and generate Face 2 as a result (where Face 1 corresponds the physical traits of the first user's face before cosmetic surgery). In another embodiment, customized adjustments or changes may have been made to the 3D face model of the first user. For example, the first user may have purchased a different 3D face model from a virtual character production company which results in Face 2 being different from Face 1.

As shown at block 202, the 3D Face Landmark Conversion Generator 182 accesses the stored historical 3D face landmarks of Face 1 for the first user from the Historical Interaction Records 184 at a last timepoint (T1) of the last historical interaction with the second user. As shown at block 204, the 3D Face Landmark Conversion Generator 182 receives the current 3D face landmarks of Face 2 at a current timepoint Tn of the current interaction between the first and second users.

At block 206, the 3D Face Landmark Conversion Generator 182 processes 3D blended face landmarks to render Face 3, which is conditioned on the historical 3D face landmarks of Face 1 202 and the current 3D face landmarks of Face 2 204. The 3D Face Landmark Conversion Generator 182 renders the third face model Face 3 of the first user at the last timepoint of the current interaction with the second user. The third face model Face 3 can incorporate all or partial facial characteristics of the first face model Face 1 of the first user. At a predefined interval in a current interaction, the 3D Face Landmark Conversion Generator 182 can update the blended 3D face landmarks of the third face model Face 3 by repeating the processing of a mismatched landmark set, so that the facial characteristics of the third face model Face 3 can be gradually changed from that of the first face model Face 1 to that of the second face model Face 2.

For example, 3D third face models can be constructed by the 3D Face Landmark Conversion Generator 182 using blended 3D face landmarks that are generated based on the 3D face landmarks of Face 1 at timepoint T1 and the 3D face landmarks of Face 2 at the current timepoint T2. At preset time intervals, a face landmark of the third face model Face 3 is randomly replaced by a face landmark with the same face-landmark index of the second face model Face 2, which do not coincide in the 3D space corresponding to the perspective of the second user's AR/VR glasses. As a result, the facial characteristics of the third face model Face 3 can gradually change from that of the first face model Face 1 to that of the second face model Face 2. One disclosed embodiment adopts hundreds of face landmarks (that is, 3D coordinates) for a single 3D face model, while other embodiments can adopt a different number of 3D face landmarks.

Initial first and second 3D face models can be constructed by the 3D Face Landmark Conversion Generator 182 based on 3D face landmarks, such as the historical 3D face landmarks generated of Face 1 at timepoint T1 and the current 3D face landmarks of Face 2 at timepoint T2.

For example, at each timepoint, the 3D Face Landmark Conversion Generator 182 samples the 3D face landmarks of the third face model through iterative refinement of T steps. That is, at each preset time interval point for rendering Face 3, face landmarks of the third face model can be randomly replaced by face landmarks with the same face-landmark index in the second face model, Face 2, which do not coincide in the 3D space corresponding to the perspective of the second user's AR/VR glasses. As a result, the facial characteristics of the third face model can be gradually changed from that of the first face model to that of the second face model. Rendering the updated face landmarks allows the third face model Face 3 to be changed at each subsequent time interval in the current interaction between the respective virtual avatars of the first and second users, for example both wearing AR/VR glasses, starting from the facial characteristics of the first face model to that of the second face model.

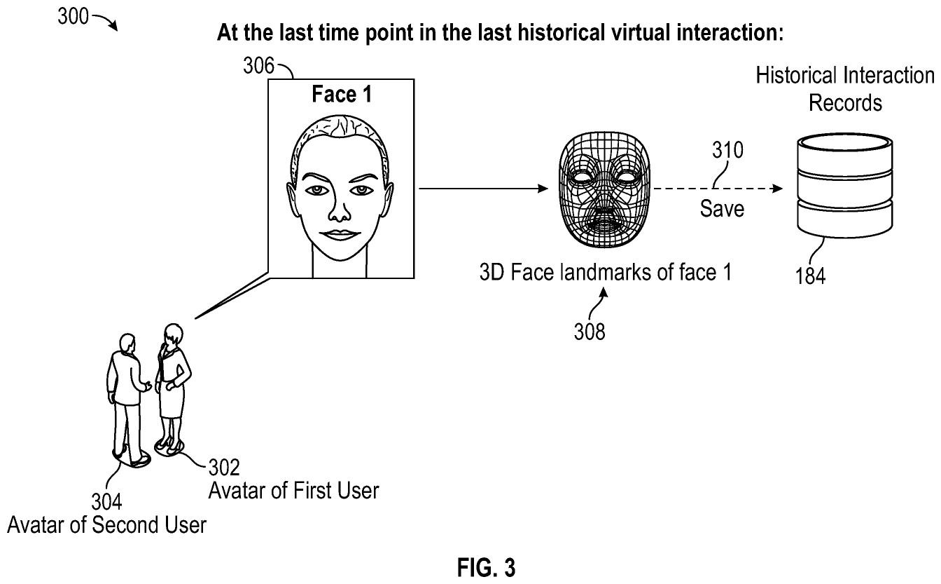

Referring also to FIG. 3 illustrated example functional operations 300 can implement generative converting 3D face landmarks of one or more disclosed embodiments. In FIG. 3, the illustrated example operations 300 include an avatar 302 for the first user and an avatar 304 for the second user who have interacted in the metaverse. A first face model or Face 1 306 is a 3D face model of the first user, for example used in a last historical interaction with the second user. Face model 1 (Face 1) is constructed using historical 3D face landmarks 308 of Face 1. For example, the 3D Face Landmark Conversion Generator 182 generated the historical 3D face landmarks 308 at timepoint T1. As indicated at a line 310, the 3D face landmarks 308 of Face 1 are saved in the Historical Interaction Records 184.

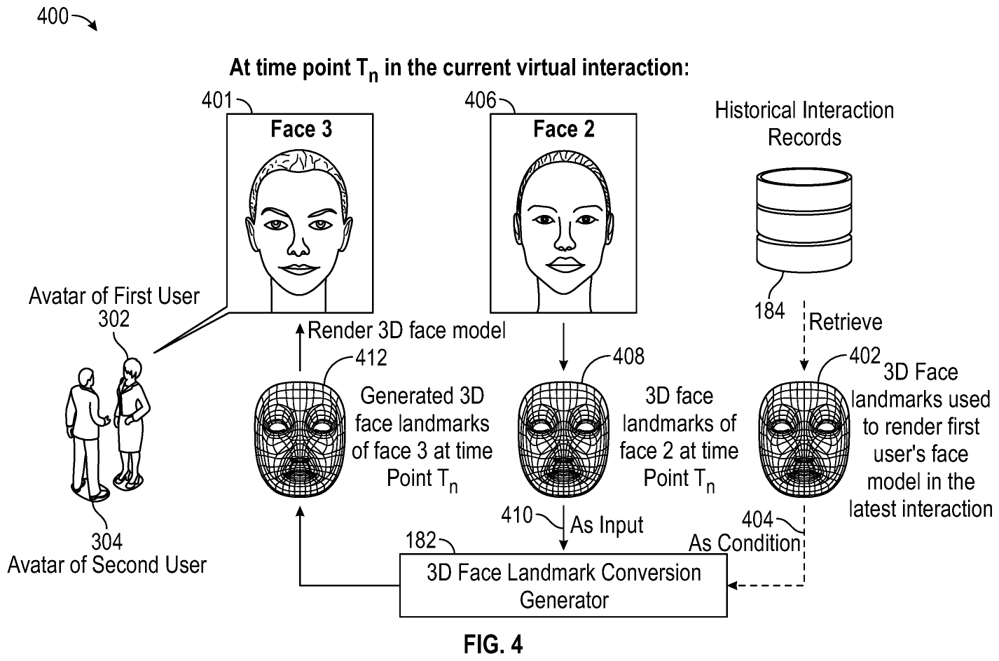

Referring also to FIG. 4, there are shown example operations 400 to retrieve 3D face landmarks of the first user from within a related historical interaction record used to render a third 3D face model Face 3 of the first user of disclosed embodiments. In FIG. 3, the avatar 302 for the first user and avatar 304 for the second user are shown for a current virtual interaction at a timepoint Tn (i.e., the current time) in the metaverse. The third face model or Face 3 401 is a 3D face model of the first user, for example that can be used in the current interaction with the second user. The 3D face landmarks 402 of Face 1 are retrieved from the Historical Interaction Records 184 and as shown at line 404 are applied to the 3D Face Landmark Conversion Generator 182 for use as a condition to render the third face model or Face 3 401. For example, the 3D face landmarks 308 generated at timepoint T1 in FIG. 3 implement the illustrated 3D face landmarks 402 of Face 1 in FIG. 4. A second face model or Face 2 406 is the current 3D face model of the first user, for example with 3D face landmarks 408 provide expression and pose of Face 2 at timepoint Tn in a current interaction with the second user. The 3D face landmarks 408 and as shown at line 410 are applied as input to the 3D Face Landmark Conversion Generator 182. Because the current, Face 2 of the first user does not match the historical Face 1 of the user, the 3D Face Landmark Conversion Generator 182 instead displays on first user's avatar Face 3 which is a blend of Face 1 and Face 2. Put differently, the second user views Face 3 instead of viewing the first user's current Face 2.

Face 3 401 is constructed using the 3D Face Landmark Conversion Generator 182, conditioned on the 3D face landmarks 402 of Face 1 at timepoint T1 and the input 3D face landmarks 408 of Face 2. The 3D Face Landmark Conversion Generator 182 generates blended 3D face landmarks 412 of Face 3 that incorporate both characteristics of Face 1 306 and expression and pose of Face 2 406 at timepoint Tn. The 3D Face Landmark Conversion Generator 182 uses the generated blended 3D face landmarks 412 of Face 3 to render Face 3 401 of disclosed embodiments.

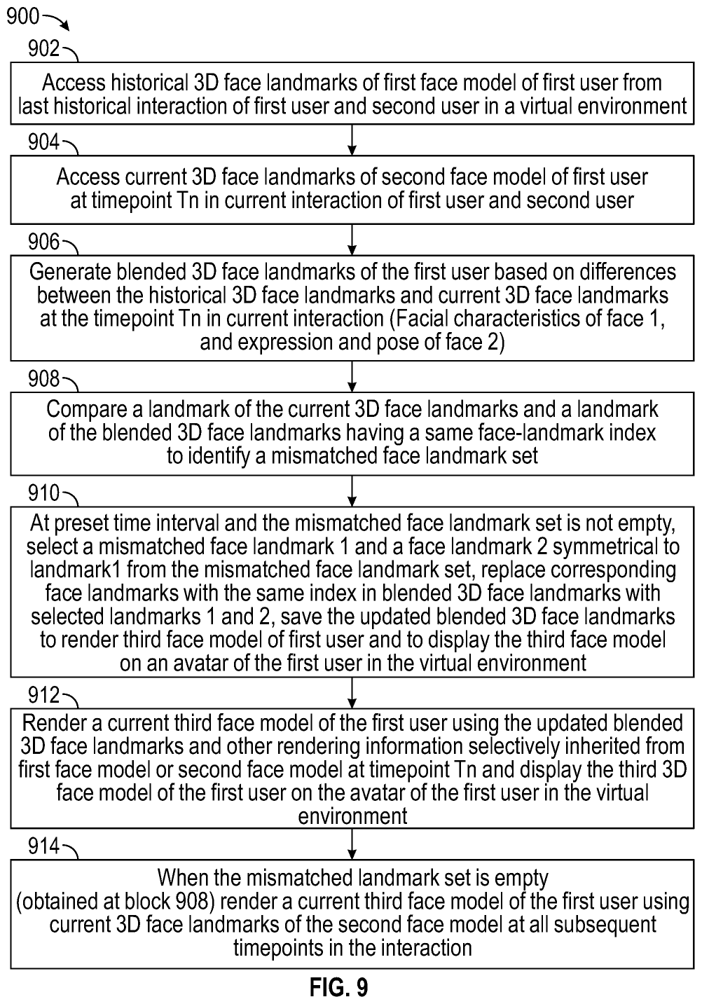

Referring to FIG. 9, there are shown example operations of a non-limiting method 900 for generative converting 3D face landmarks of one or more disclosed embodiments. As indicated at block 902, the 3D Face Landmark Conversion Generator 182 accesses the historical 3D face landmarks used to render the 3D first face model Face 1 of first user from within the Historical Interaction Records 184, as the condition to guide the 3D Face Landmark Conversion Generator 182. At timepoint T1, the historical 3D face landmarks are that of the first face model Face 1 captured at the last timepoint Tn in the last historical interaction with second user.

At block 904 the 3D Face Landmark Conversion Generator 182 accesses or takes in as input the current 3D face landmarks of the second face model Face 2 of the first user in the current interaction of the first user and the second user, which are captured based on the perspective of the second user's AR/VR glasses at timepoint Tn, to present a real-time expression and pose of Face 2 406 at that timepoint Tn.

At block 906, at the current timepoint Tn in the current interaction, the 3D Face Landmark Conversion Generator 182 generates the blended 3D face landmarks of the third face model Face 3 based on differences between the historical 3D face landmarks and the current 3D face landmarks; which presents the same expression and pose as that of Face 2 at timepoint Tn and for example has the same facial characteristics of the historical 3D face landmarks of Face 1, as retrieved at block 902.

At block 908, the 3D Face Landmark Conversion Generator 182 compares a face landmark in the current the 3D face landmarks with a face landmark in the blended 3D face landmarks which has the same face-landmark index, in order to identify all mismatched face landmarks and provide a mismatched landmark set. That is, two face landmarks with the same face-landmark index are two different coordinate points in the three-dimensional space that corresponds to the perspective of the second user's AR/VR glasses at timepoint Tn.

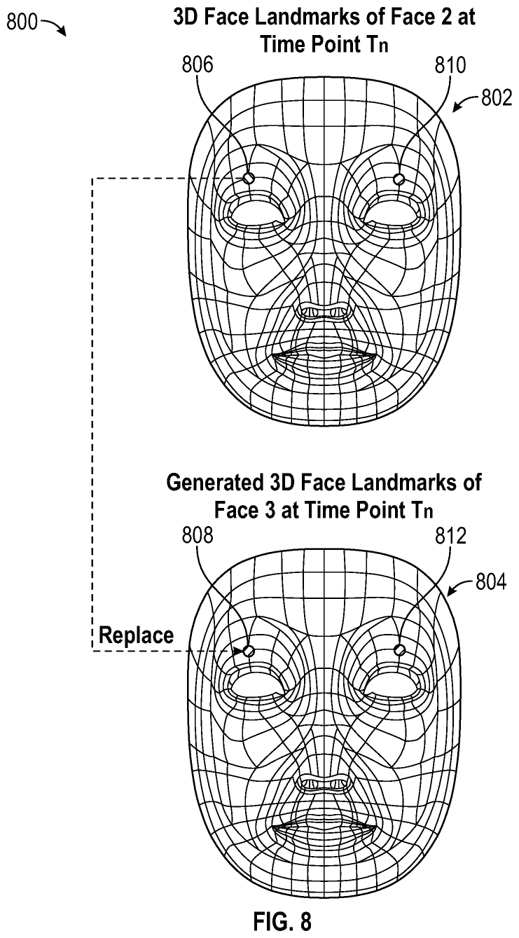

At block 910, at a preset time interval in the current interaction, which can be an integer multiple of a time interval preset by the second user (such as default is 10 minutes) and the mismatched landmark set is not empty; the 3D Face Landmark Conversion Generator 182 can randomly select a mismatched face landmark 1 and a face landmark 2 symmetrical to the landmark 1 from the mismatched landmark set. The 3D Face Landmark Conversion Generator 182 replaces corresponding face landmarks with the same face-landmark index in the blended 3D face landmarks with the selected landmarks 1 and 2 from the mismatched landmark set; and saves the updated blended 3D face landmarks to the related historical interaction record in the Historical Interaction Records 184. The 3D Face Landmark Conversion Generator 182 uses the updated blended 3D face landmarks to render the third 3D face model of the first user and to display the third 3D face model on the avatar of the first user in the virtual environment. FIG. 8 illustrates example operations 800 for updating 3D face landmarks used for generative converting 3D face landmarks of one or more disclosed embodiments.

In FIG. 8, there are shown first 3D face landmarks 802 that indicate the second face model Face 2 802 of the first user, and blended 3D face landmarks 804 that indicate the third face model Face 3 804 of the first user in the 3D metaverse space corresponding to the perspective of the second user's AR/VR glasses at timepoint Tn. For example, the example 3D face landmarks 802, 804 respectively indicate the second face model Face 2 802 and the third face model 804 at timepoint Tn in a current interaction of the first and second users who have interacted in the metaverse, such as with the avatar 302 for the first user, and the avatar 304 for the second user as shown in FIG. 3. In a certain preset interval (such as a default interval of 10 minutes) during the current virtual interaction between the first and second users, assume that a first landmark 806 of the Face 2 802 (obtained at timepoint Tn) does not coincide with a generated landmark 808 of the Face 3 804, where the first face landmark 806 of Face 2 802 and the generated landmark 808 of the Face 3 804 have the same face-landmark index. The first face landmark 806 of Face 2 802 and its symmetrical face landmark 810 of Face 2 can be randomly selected in order to replace the generated face landmark 808 and its symmetrical face landmark 812 of Face 3 804. In this way, the Face 3 804 generated at later or subsequent timepoints can gradually incorporate more and more characteristics of Face 2 after many intervals. As a result, the first user can be easily recognized by the second user from the generated third face models of Face 3. While the second user was only familiar with the first face model Face 1 of the first user and the first face model was replaced with a substantially different second face model Face 2, the generated third face models of Face 3 of the disclosed face-landmark generative process enable users to easily recognize others whose first and second 3D face models have been significantly changed.

Returning to FIG. 9, at block 912 the 3D Face Landmark Conversion Generator 182 renders the current third 3D face model or the second 3D face model of the first user at timepoint Tn using the updated blended 3D face landmarks. The 3D Face Landmark Conversion Generator 182 displays the third face model on the avatar of the first user in the virtual environment. Other information required for rendering the 3D face model (e.g., vertex texture coordinates) is inherited from Face 1 or 2, according to the ratio of the size of the mismatched landmark set to the total number of blended 3D face landmarks on an entire face such as the current third face model. For example, if this ratio is less than 40%, the rendering information is inherited from Face 2; otherwise, it is inherited from Face 1.

At block 914, when the mismatched landmark set at a certain timepoint is empty, the 3D Face Landmark Conversion Generator 182 will use the real-time 3D face landmarks of Face 2 to render the 3D face model of the first user at all subsequent timepoints in the interaction, and the rendering information is directly inherited from Face 2.

In the process of method 900, the second user has a chance to gradually become familiar with Face 2 of the first user's virtual avatar from Face 1. If the mismatched landmark set is still not empty at the last timepoint of the current interaction, the same process of method 900 can be performed in future interactions between first and second users, until the mismatched landmark set becomes empty in a certain future interaction.

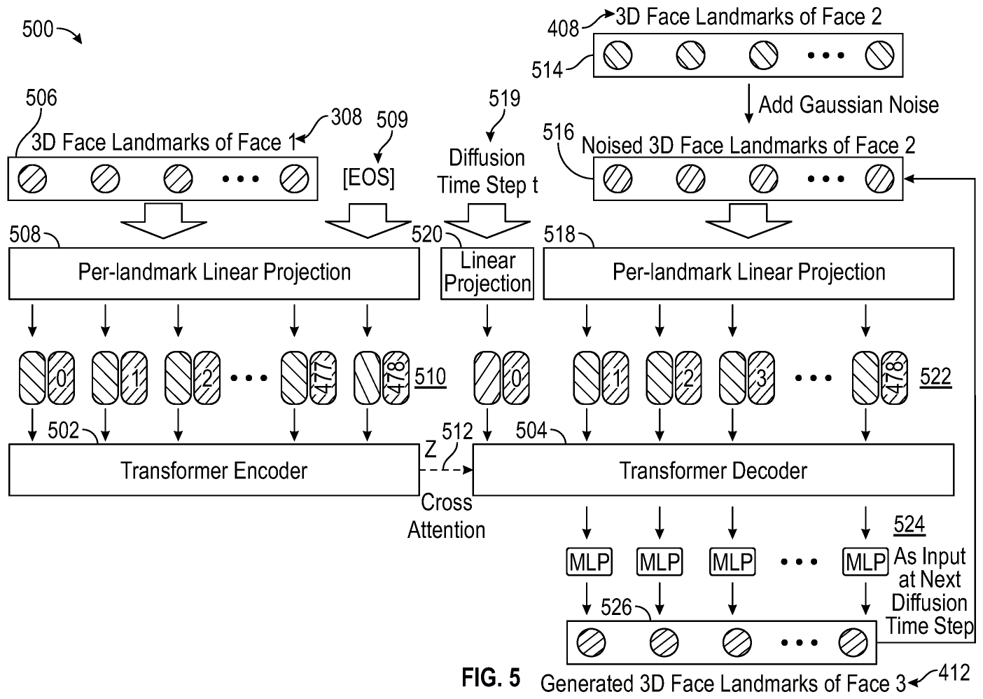

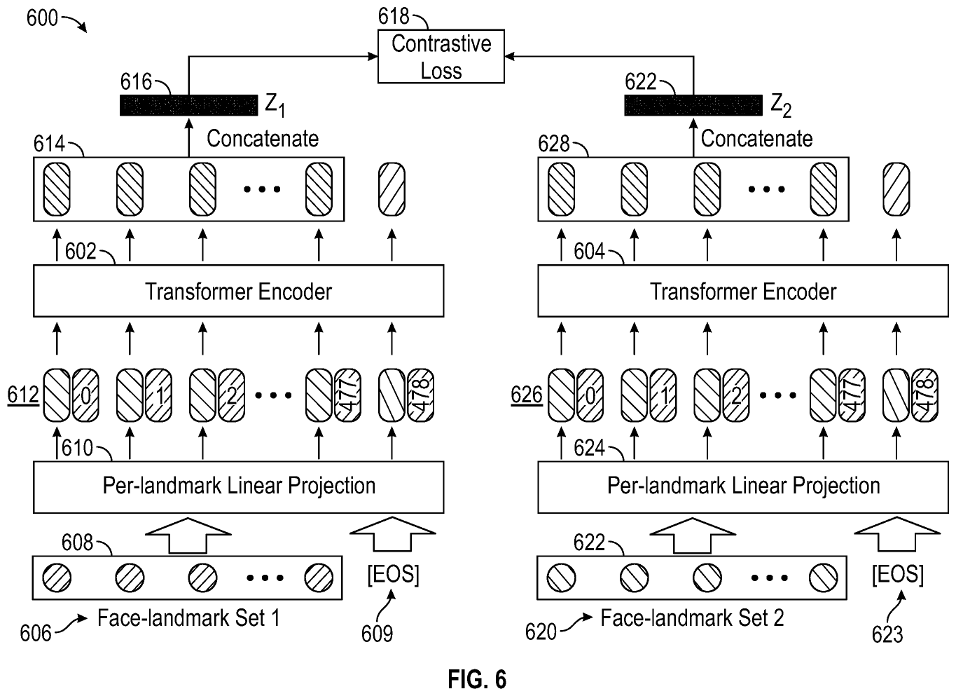

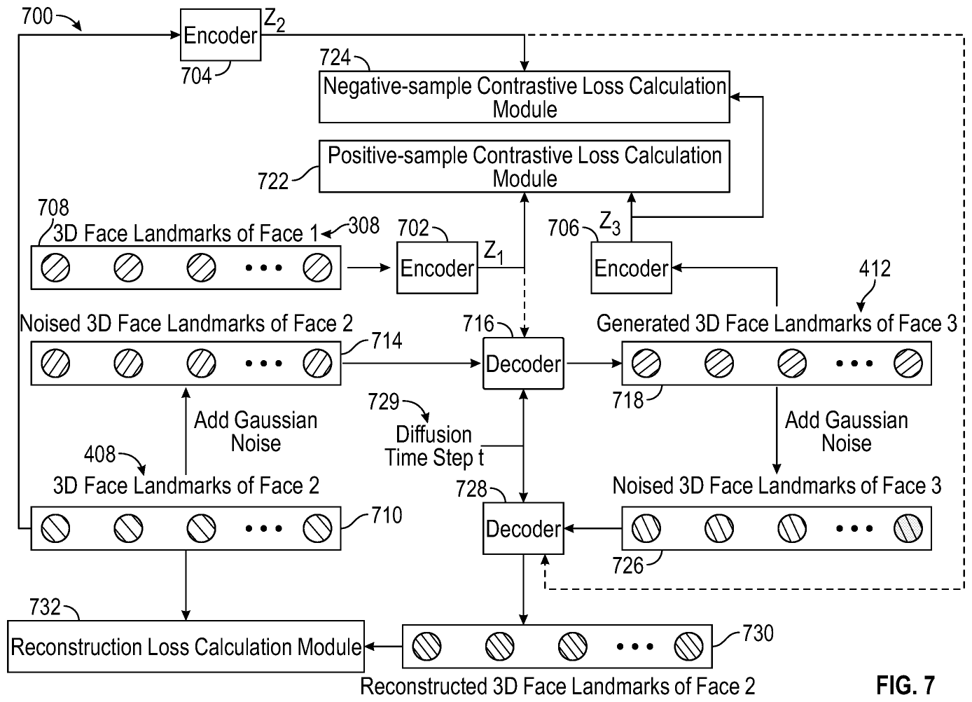

The 3D Face Landmark Conversion Generator 182, similar to Denoising Diffusion Probabilistic Models (DDPM), is a conditional non-autoregressive generative model based on iterative refinement, for example employing a Transformer encoder-decoder architecture, such as illustrated in FIG. 5, with causality masking in the decoder being removed. FIGS. 5, 6, and 7 provide example implementation functions and operations of the 3D Face Landmark Conversion Generator 182 for implementing generative converting 3D face landmarks of one or more disclosed embodiments. For example, at each timepoint of method 900, the 3D Face Landmark Conversion Generator 182 samples the 3D face landmarks of the third face model Face 3 through iterative refinement of T steps, such as illustrated in FIG. 5. FIG. 6 illustrates an example implementation model of functions and operations of encoder pretraining. FIG. 7 illustrates an example implementation model of two-stage training of the decoder.

FIG. 5 illustrates an example Implementation model 500 of functions and operations of iterative refinement of 3D face landmarks during inference of the 3D Face Landmark Conversion Generator 182 for implementing generative converting 3D face landmarks of disclosed embodiments. The Implementation model 500 includes an encoder 502 and a decoder 504, such as a transformer encoder 502 and a transformer decoder 504. The 3D face landmarks 308 of Face 1 are applied to an input 506 and are coupled to a per-landmark linear projection layer 508. The per-landmark linear projection layer 508 receives a separator token end-of-sequence (EOS) 509. The per-landmark linear projection layer 508 is coupled to the transformer encoder 502. The transformer encoder 502 provides a cross-attention input indicated at line 512 to the transformer decoder 504.

The 3D face landmarks 408 of Face 2 are applied to an input 514 and are coupled via a Gaussian noise block 516 to a per-landmark linear projection layer 518. A diffusion time step 519 is coupled to a linear projection 520. The per-landmark linear projection layer 518 and linear projection 520 are coupled to the transformer decoder 504. An output of the transformer decoder 504 that corresponds to an input 3D face landmark, is converted to a three-dimensional vector through a Multilayer Perceptron (MLP) 524 for generated 3D face landmarks of Face 3 412 at output 526.

For example, in the Implementation model 500 of 3D Face Landmark Conversion Generator 182, there are L (e.g. 6) attention layers for both the encoder 502 and the decoder 504, K (e.g. 8) attention heads, 512 model dimensions and 512 hidden dimensions. The encoder 502 and the decoder 504 respectively takes in as input a sequence of M 3D face landmarks, sorted according to the face-landmark indices, where M is the total number of 3D face landmarks on an entire face, e.g., 478 3D face landmarks. In operation, the separator token end-of-sequence (EOS) 509, represented as a three-dimensional zero vector, is added as the last element of the encoder's input sequence 510; diffusion time step t 519 is inserted into the decoder's input sequence 522 as the first element. Each 3D face landmark in the input 506 or the separator token 509 is linearly projected to a 512-dimensional token embedding through the per-landmark linear projection layer 508. The diffusion time step t, represented as a one-hot encoding embedding of dimension T (that is, maximum diffusion time step), is linearly projected to a 512-dimensional token embedding through the linear projection layer 520. Every final input embedding in the input sequence 510 or 522 is the sum of a 512-dimensional token embedding and a corresponding 512-dimensional position embedding. The output 512 of the encoder 502 (that is, feature matrix Z) is used by every encoder-decoder attention layer in the decoder 504. Each 512-dimensional output of the decoder 504 that corresponds to an input 3D face landmark, is converted to a three-dimensional vector through the MLP 524, which represents the generated 3D face landmarks of Face 3 412 at output 526.

The 3D face landmarks of Face 1 are fed or input into the encoder 502 in order to obtain feature matrix Z for cross attention at output line 512. Each coordinate value of the 3D face landmarks of Face 2 at timepoint Tn is added Gaussian noise 516, which is calculated using the following formula based on the value of the diffusion time step t (t=T):

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I )$$

Where aₜ:=1−βₜ; α̅ₜ=Πₛ₌₁^{t} αₛ; βₜ is a linear schedule (e.g., from β₁=10⁻⁴ to β_{T}=0.02); x₀ indicates an original coordinate value; xₜ indicates a noised coordinate value with the added Gaussian noise corresponding to the specific diffusion time step t. For example, consider a straight line in the x-y plane and T set to 1000. Now, there are a total of 1000 discrete 2D points on the line, and their respective 2D coordinate values are (1, β₁), (2, β₂), (3, β₃), . . . (T, β_{T}). In some embodiments, the values of β₁ and β_{T} are pre-determined according to experience (e.g., by expert or empirical data). Continuing with this example, β₁ and β_{T} are set to the values 10⁻⁴ and 0.02, respectively, although other values are possible and within the contemplated scope of one or more disclosed embodiments. The values of the other βₜ elements are determined according to the related x coordinate value (that is, the value of t; where/denotes the diffusion time step).

The diffusion time step t (t=T) and the noised 3D face landmarks of Face 2 are fed or input into the decoder in order to generate the 3D face landmarks of Face 3 at diffusion time step t (t=T). Later, feed the next diffusion time step t (t=T−1) and the 3D face landmarks of Face 3, which are generated at the previous diffusion time step, into the decoder again in order to generate the 3D face landmarks of Face 3 at diffusion time step t (t=T−1) Repeat T times in this way, the final 3D face landmarks of Face 3 at timepoint T is obtained. Moreover, if more than 98% of the 3D face landmarks generated at a certain diffusion time step, compared with those generated at the previous diffusion time step, are the same, the iterative refinement process can be stopped in less than T steps.

A training dataset can be built, for example for use to pretrain the encoder as follows. The 3D face landmarks of a single person captured at any timepoint are considered as a face-landmark set. Face-landmark sets of every single person can be obtained from within a large number of available online/offline videos with characters through 3D face landmark recognition technology (e.g., MediaPipe Face Mesh). Then, those face-landmark sets are grouped by different people, through face recognition technology, to form a training dataset.

FIG. 6 illustrates an example Implementation model 600 of functions and operations to pretrain encoder 502 for implementing generative converting 3D face landmarks of one or more disclosed embodiments.

The Implementation model 600 includes a pair of encoders 602 and 604, which share the same parameters as transformer encoders 602 and 604. The 3D face landmark set 1 606 is applied to an input 608 and coupled to a per-landmark linear projection layer 610. The per-landmark linear projection layer 610 receives a separator token end-of-sequence (EOS) 609. The per-landmark linear projection layer 610 is coupled to the transformer encoder 602. The transformer encoder 602 provides vector outputs 614 applied and concatenated at a vector block 616 providing vector Z1.

The 3D face landmark set 2 620 is applied to an input 622 and coupled to a per-landmark linear projection layer 624. The per-landmark linear projection layer 624 receives a separator token end-of-sequence (EOS) 623. The per-landmark linear projection layer 624 is coupled to the transformer encoder 604. The transformer encoder 604 provides vector outputs 628 applied and concatenated at a vector block 622 providing vector Z2.

In operation, the Implementation model 600 is used to pretrain encoders 602 and 604, which share the same parameters. Face landmark sets 1 and 2, 606 and 620 can be randomly selected from the training dataset and fed into two encoders 602 and 604, respectively. All output feature vectors (each of size 1×512) from one encoder, (e.g. encoder 602), except for that corresponds to the separator token [EOS] 609, are concatenated into a vector of size 1×(512×M), and contrastive loss 618 is calculated between the respective concatenated vectors of two encoders (aka Z₁ and Z₂) using the following formula:

$${L}_{E} = \frac{1}{2} [ Y * {( {‖ {Z}_{1} - {Z}_{2} ‖}_{2} )}^{2} + ( 1 - Y ) * {max ( m - {‖ {Z}_{1} - {Z}_{2} ‖}_{2} , 0 )}^{2} ]$$

Where, Y is training label; Y=1 indicates face-landmark sets 1 and 2 belong to the same person, and Y=0 indicates they belong to different persons; m is a preset threshold. Use backpropagation to update the parameters of the encoder and the per-landmark linear projection layer.

FIG. 7 illustrates an example Implementation model 700 of functions and operations of an example two-stage training of a decoder for implementing generative converting 3D face landmarks of one or more disclosed embodiments. FIG. 7 depicts a two-stage training of the decoder 504 of FIG. 5.

The Implementation model 700 includes a first encoder 702, a second encoder 704, and a third encoder 706, where the encoders 702, 704 and 706 in FIG. 7 are the same as pre-trained encoder 602 and 604 in FIG. 6. A pair of decoders 716 and 728 in FIG. 7 are the same as the decoder to be trained. The 3D face landmarks 308 of Face 1 are applied to an input 708 and are coupled to the first encoder 702, providing Z₁ which is the output feature matrix from the encoder 702, corresponding to the 3D face landmarks 308 of Face 1. The 3D face landmarks 408 of Face 2 are applied to an input 710 and are coupled to the second encoder 704 providing Z₂ which is the output feature matrix from the encoder 704, corresponding to the input 3D face landmarks 408 of Face 2. The generated 3D face landmarks 412 of Face 3 are applied to the third encoder 706, providing Z₃, which is the output feature matrix from the encoder 706, corresponding to the generated 3D face landmarks 412 of Face 3.

The 3D face landmarks 408 of Face 2 are coupled to an input 714 with Gaussian noise added. The noised 3D face landmarks of Face 2 are applied a decoder 716. The Z₁ output feature matrix from the encoder 702 is applied to the decoder 716, indicated by dotted line. The decoder 716 provides an input 718 of the generated 3D face landmarks 412 of Face 3 coupled to the encoder 706. The Z₁ output feature matrix from the encoder 702 is applied to a positive-sample contrastive loss calculation module 722. The Z₂ output feature matrix from the encoder 704 is applied to a negative-sample contrastive loss calculation module 724. The output feature matrix from the encoder 706 is applied to both the positive-sample contrastive loss calculation module 722 and the negative-sample contrastive loss calculation module 724.

The generated 3D face landmarks 412 of Face 3 are coupled to an input 726 with Gaussian noise added. The noised 3D face landmarks of Face 3 are applied a second decoder 728. The Z₂ output feature matrix from the encoder 704 is applied to the second decoder 728, indicated by dotted line. A diffusion time step t 729 is applied to both the first decoder 716 and the second decoder 728.

The decoder 728 provides reconstructed 3D face landmarks of Face 2 to an input 730, which are applied to a reconstruction loss calculation module 732. The reconstruction loss calculation module 732 receives the 3D face landmarks 408 of Face 2 coupled from input 710.

In decoder training operation, for example two face-landmark sets are randomly selected from any two groups (that is, belonging to two persons) in the training dataset. one face-landmark set is considered as 3D face landmarks of Face 1, and the other face-landmark set is considered as 3D face landmarks of Face 2. The decoder 716 is assumed to generate the 3D face landmarks of Face 3 based on the input 3D face landmarks of Face 2 in one run at the first stage, conditioned on the 3D face landmarks of Face 1 (via cross attention). The decoder 728 reconstructs the 3D face landmarks of Face 2 based on the generated 3D face landmarks of Face 3 at the second stage, conditioned on the input 3D face landmarks of Face 2 that is involved at the first stage. The reconstruction loss calculation module 732 calculates the reconstruction loss between the input and reconstructed face-landmark sets of Face 2, to guide the decoder to generate a face-landmark set whose expression and pose are as similar to that of the input 3D face landmarks of Face 2 as possible. The positive-sample contrastive loss calculation module 722 calculates positive-sample contrastive loss based on the generated 3D face landmarks of Face 3 and the 3D face landmarks of Face 1 through the encoders 702 and 706 respectively, so as to guide the decoder 716 to generate a face-landmark set whose characteristics for example, are as similar to that of Face 1 as possible. The negative-sample contrastive loss calculation module 724 calculates negative-sample contrastive loss is calculated based on the generated 3D face landmarks of Face 3 and the input 3D face landmarks of Face 2, for example to guide the decoder 716 to generate a face-landmark set whose characteristics are as dissimilar to that of Face 2 as possible.

The equation W⁽⁰⁾=G_{θ}(γ^{(t)}, Z₁, t) describes the first stage (that is, the decoder 716 generates 3D face landmarks of Face 3 based on the input 3D face landmarks of Face 2), wherein: t indicates the current diffusion time step, which is uniformly selected from a sequence of integers [1,7] at random. Z₁ is the output feature matrix from the encoder 702, which corresponds to the 3D face landmarks of Face 1, and the decoder is conditioned on Z₁ via cross attention at the first stage. γ^{(t)} indicates the noised 3D face landmarks of Face 2 through adding Gaussian noises to the input 3D face landmarks of Face 2 (marked as Y⁽⁰⁾). G_{θ}(⋅) indicates the prediction performed by the decoder and θ indicates the parameters of the decoder. W⁽⁰⁾ indicates the generated 3D face landmarks of Face 3.

The equation U=G_{θ}(W^{(t)}, Z₂, t) describes the second stage (that is, the decoder 728 reconstructs the 3D face landmarks of Face 2 based on the generated 3D face landmarks of Face 3), wherein: t is the same diffusion time step as that of the first stage. Z₂ is the output feature matrix from the encoder, which corresponds to the input 3D face landmarks of Face 2 (that is, Y⁽⁰⁾), and the decoder is conditioned on Z₂ via cross attention at the second stage. W^{(t)} indicates the noised 3D face landmarks of Face 3 through adding Gaussian noises to the 3D face landmarks of Face 3 generated at the first stage (that is, W⁽⁰⁾). U indicates the reconstructed 3D face landmarks of Face 2.

Below is the overall loss function of the decoder provided by the reconstruction loss calculation module 732, the positive-sample contrastive loss calculation module 722 and the negative-sample contrastive loss calculation module 724:

$${L}_{D} = 𝔼 [ α * {( {‖ U - {Y}^{( 0 )} ‖}_{2} )}^{2} + β * {( {‖ {E}_{φ} ( {W}^{( 0 )} ) - {Z}_{1} ‖}_{2} )}^{2} + γ * {max ( m - {‖ {E}_{φ} ( {W}^{( 0 )} ) - {Z}_{2} ‖}_{2} , 0 )}^{2} ]$$

Where: The first item is the reconstruction loss. The second item is the positive-sample contrastive loss. The third item is the negative-sample contrastive loss. m is a preset threshold. E_{φ}(⋅) indicates the output feature matrix from the encoder (that is, Z₃ in FIG. 7) and φ indicates the parameters of the encoder. α, β and γ are hyperparameters that control the relative weights of the three items.

Backpropagation can be used to update the parameters of the decoder 504, the linear projection layer 520 and the MLP 524. During the training of the decoder 504, the parameters of the encoder 502 and the per-landmark linear projection layers 508 and 518 are frozen.

While the foregoing is directed to embodiments of the present invention, other and further embodiments of the invention may be devised without departing from the basic scope thereof, and the scope thereof is determined by the claims that follow.

What is claimed is:

1. A method comprising:
accessing historical 3D face landmarks of a first face model of a first user from a last historical interaction between the first user and a second user in a virtual environment;
accessing current 3D face landmarks of a second face model of the first user at a timepoint Tn in a current interaction of the first user and the second user in the virtual environment, wherein the current 3D face landmarks of a second face model present an expression and pose of the first user;
generating blended 3D face landmarks of the first user based on differences between the historical 3D face landmarks and the current 3D face landmarks of the first user;
rendering a third face model for the first user based on the blended 3D face landmarks, wherein the expression and pose of the third face model matches the expression and pose of the second face model; and
displaying the third face model on an avatar of the first user in the virtual environment.

2. The method of claim 1, wherein the second face model includes changes from the first face model of the first user, wherein the third face model incorporates facial characteristics of the first face model of the first user enabling the second user to recognize the first user.

3. The method of claim 1, further comprises storing generated blended 3D face landmarks of the third face model in a Historical Interaction Records and wherein the historical 3D face landmarks of the first face model are stored in the Historical Interaction Records.

4. The method of claim 1, further comprises comparing a face landmark of the current 3D face landmarks of a second face model and a face landmark of the blended 3D face landmarks of the third face model having a same face-landmark index to identify a mismatched face landmark set at the timepoint Tn, and processing the mismatched face landmark set to update the blended 3D face landmarks of the third face model.

5. The method of claim 4, wherein processing the mismatched face landmark set to update the blended 3D face landmarks of the third face model comprising:
randomly selecting a mismatched face landmark 1 and a face landmark 2 symmetrical to the mismatched face landmark 1 of the mismatched face landmark set and replacing corresponding face landmarks with the same face-landmark index in the blended 3D face landmarks, and
saving replaced corresponding face landmarks to provide updated blended 3D face landmarks to render a current third face model of the first user.

6. The method of claim 4, further comprises repeating the processing of the mismatched face landmark set to update the blended 3D face landmarks of the third face model at subsequent next timepoints Tn at a preset time interval in the current interaction of the first user and second user.

7. The method of claim 6, wherein repeating the processing of the mismatched face landmark set to update the blended 3D face landmarks of the third face model at subsequent next timepoints Tn at a preset time interval in the current interaction sequentially incorporates updated blended 3D face landmarks of the third face model, and sequentially changes at least some facial characteristics of the third face models from the first face model to the second face model.

8. The method of claim 1, further comprising:
comparing a face landmark of the current 3D face landmarks of a second face model and a face landmark of the blended 3D face landmarks of the third face model having a same face-landmark index to identify a mismatched face landmark set at the timepoint Tn, and identifying an empty mismatched face landmark set, and
rendering a current third face model of the first user presented to the second user with the current 3D face landmarks of the second face model.

9. The method of claim 1, further comprises comparing a face landmark of the current 3D face landmarks of a second face model and a face landmark of the blended 3D face landmarks of the third face model having a same face-landmark index to identify a mismatched face landmark set at the timepoint Tn, and identifying a ratio of a size of the mismatched landmark set to a total number of the blended 3D face landmarks of the third face model.

10. The method of claim 9, wherein rendering a third face model for the first user with the blended 3D face landmarks of the third face model comprises inheriting additional information for rendering the third face model from one of the first face model and the second face model based on the identified ratio.

11. A system, comprising:
a processor; and
a memory, wherein the memory includes a computer program product configured to perform operations for generating third 3D face models of a first user enabling a second user to recognize the first user, wherein the second user recognizes a first face model of the first user; and with a current second face model of the first user replacing the first face model, the second user cannot recognize the first user, the operations comprising:
accessing historical 3D face landmarks of a first face model of a first user from a last historical interaction between the first user and a second user in a virtual environment;
accessing current 3D face landmarks of a second face model of the first user at a timepoint Tn in a current interaction of the first user and the second user in the virtual environment, wherein the current 3D face landmarks of a second face model present an expression and pose of the first user;
generating blended 3D face landmarks of the first user based on differences between the historical 3D face landmarks and the current 3D face landmarks of the first user;
rendering a third face model for the first user based on the blended 3D face landmarks, wherein the expression and pose of the third face model matches the expression and pose of the second face model; and
displaying the third face model on an avatar of the first user in the virtual environment.

12. The system of claim 11, further comprises storing generated blended 3D face landmarks of the third face model in a Historical Interaction Records and wherein the historical 3D face landmarks of the first face model are stored in the Historical Interaction Records.

13. The system of claim 11, wherein the third face model incorporates facial characteristics of the first face model of the first user enabling the second user to recognize the first user.

14. The system of claim 11, further comprises comparing a face landmark of the current 3D face landmarks of a second face model and a face landmark of the blended 3D face landmarks of the third face model having a same face-landmark index to identify a mismatched face landmark set at the timepoint Tn, and processing the mismatched face landmark set to update the blended 3D face landmarks of the third face model.

15. The system of claim 14, wherein processing the mismatched face landmark set to update the blended 3D face landmarks of the third face model comprises:
randomly selecting a mismatched face landmark 1 and a face landmark 2 symmetrical to the landmark 1 of the mismatched face landmark set and replacing corresponding face landmarks with the same face-landmark index in the blended 3D face landmarks, and
saving the replaced corresponding face landmarks to provide updated blended 3D face landmarks to render a current third face model of the first user.

16. A computer program product for generating a third 3D face models of a first user enabling a second user to recognize the first user, wherein the second user recognizes a first face model of the first user; and with a current second face model of the first user replacing the first face model, the second user cannot recognize the first user, the computer program product comprising:
a computer-readable storage medium having computer-readable program code embodied therewith, the computer-readable program code executable by one or more computer processors to perform an operation comprising:
accessing historical 3D face landmarks of a first face model of a first user from a last historical interaction between the first user and a second user in a virtual environment;
accessing current 3D face landmarks of a second face model of the first user at a timepoint Tn in a current interaction of the first user and the second user in the virtual environment, wherein the current 3D face landmarks of a second face model present an expression and pose of the first user;
generating blended 3D face landmarks of the first user based on differences between the historical 3D face landmarks and the current 3D face landmarks of the first user;
rendering a third face model for the first user based on the blended 3D face landmarks, wherein the expression and pose of the third face model matches the expression and pose of the second face model; and
displaying the third face model on an avatar of the first user in the virtual environment.

17. The computer program product of claim 16, further comprises storing generated blended 3D face landmarks of the third face model in a Historical Interaction Records and wherein the historical 3D face landmarks of the first face model are stored in the Historical Interaction Records.

18. The computer program product of claim 16, wherein the third face model incorporates facial characteristics of the first face model of the first user enabling the second user to recognize the first user.

19. The computer program product of claim 16, further comprises comparing a face landmark of the current 3D face landmarks of a second face model and a face landmark of the blended 3D face landmarks of the third face model having a same face-landmark index to identify a mismatched face landmark set at the timepoint Tn, and processing the mismatched face landmark set to update the blended 3D face landmarks of the third face model.

20. The computer program product of claim 19, further comprises repeating the processing of the mismatched face landmark set to update the blended 3D face landmarks of the third face model at subsequent next timepoints Tn at a preset time interval in the current interaction of the first user and second user.
